(19) United States
(12) Patent Application Publication
(10) Pub. No.: US 2016/0126734 A1
(43) Pub. Date: May 5, 2016

(54) A Microgrid Control Apparatus, Method and System for Controlling Energy Flow within a Microgrid

(71) Applicant: SWANBARTON LIMITED, Sherston, Malmesbury, Wiltshire (GB)

(72) Inventors: Anthony Price, Sherston, Malmesbury (GB); Clive Tomlinson, Bradford on Avon (GB); Jill Cainey, Sherston, Malmesbury (GB)

(73) Assignee: Swanbarton Limited, Sherston, Malmesbury, Wiltshire (GB)

(21) Appl. No.: 14/891,078

(22) PCT Filed: May 13, 2014
(86) PCT No.: PCT/IB2014/061402

§ 371 Date: Nov. 13, 2015

(30) Foreign Application Priority Data
May 13, 2013 (GB) 1308582.4

(51) Int. Cl. H02J 3/00; G05B 13/02

(52) U.S. Cl. CPC H02J 3/005; G05B 13/026

(57) ABSTRACT

The amount of energy generation and energy storage equipment connected to centralised grids by end users is expected to increase in the future. Electricity transformers/substations, have only limited capacity and are not designed for reverse energy flow due to electricity generation by an end user. The rising trend for home generation may cause damage to such transformers/substations, and may prove very costly to replace. The present invention relates generally to a microgrid control apparatus, method and system for controlling energy flow within a microgrid such that reverse flow through a transformer/substation is minimised.

### BACKGROUND

The present invention relates generally to a microgrid control apparatus, method and system for controlling energy flow within a microgrid and finds particular, although not exclusive, utility in controlling electrical energy flow within a low voltage network, more particularly in an electrical network isolated by a transformer and/or substation handling a power of below approximately 5 MW.

In conventional centralised grid topologies, long-distance flows of energy from generation sites to end users lose a substantial amount of energy as heat. Historically, this has been accepted in the field. To minimise this, power is transferred long distances at high voltage, and is stepped down to lower voltages on reaching an end user. In particular, in urban areas, electricity transformers/substations may be found spaced apart by approximately 500 m, with each transformer/substation supplying power to a group of end users via low voltage feeders or low voltage feeder cables.

The amount of energy generation and energy storage equipment connected to centralised grids by end users is expected to increase in the future. Energy generation equipment may include fuel cells, wind, solar, or other energy sources that include renewable energy generation devices. Energy storage equipment may include electrical storage systems, dedicated battery systems, electric car batteries and refrigeration and heating systems, including water heating systems, refrigerators and freezers. In addition, there is expected to be an increase in electrical demand in the future, due to increased reliance on electrical equipment (for example, by the introduction of heat pumps into home heating systems).

Electricity transformers and/or substations, and low voltage feeders and/or feeder cables, have only limited capacity that may not be enough for increased energy flows due to the additional equipment. For instance, this may be due to electric heating of various components. Historically, as demand grew, these components were replaced and/or upgraded to cope.

In addition, electricity transformers and/or substations are not designed for reverse energy flow due to electricity generation by an end user. The rising trend for home generation may cause damage to such transformers/substations, and may prove very costly to replace.

A microgrid may be a geographically localised group of energy generation equipment, energy storage equipment, and energy consumption equipment (e.g. loads). A microgrid may be connected to a centralised grid (e.g. a macrogrid, such as a national grid, a regional distribution network and/or a transmission/distribution network) at a single point that operates as an input or an output, depending on the energy consumption/generation of the microgrid. Alternatively, a microgrid may be isolated permanently, semi-permanently, occasionally and/or temporarily. Energy generation equipment, energy storage equipment, and energy consumption equipment may be connected in a microgrid at low voltage, for instance via low voltage feeders or low voltage feeder cables. Low voltage may be below approximately 500V, 400V, 300V, 250V, 240V, 230V or 220V. The input/output of the microgrid is usually a transformer and/or substation, for instance a 2 MW substation. The isolating transformer/substation may have a power rating of below approximately 50 MVA, 40 MVA, 20 MVA, 10 MVA, 5 MVA, 4 MVA, 3 MVA, 2 MVA, 1 MVA, 500 kVA, 400 kVA, 300 kVA or 250 kVA. The microgrid may comprise a local energy network, power lines, cables, substations, transformers, distribution wiring, meters, junction boxes, switches and/or circuit breakers. In some arrangements, a microgrid may be defined as comprising all connected components within the geographically localised group, or that are connected to the centralised grid via the single point, or even all components connected to the low voltage side of the transformer and/or substation. Alternatively, the microgrid may be defined as that part of the geographically localised group and/or connected components that may be subject to monitoring and/or control by the microgrid control apparatus of the present invention.

### SUMMARY

The present invention may seek to optimise the transfer of energy within a microgrid in order to reduce the demand placed on existing transformers and/or substations. In order to achieve this, it is useful to appreciate the manner in which electrical energy is exchanged between generator businesses and energy suppliers (often large national companies). Historically, electrical energy exchange has dealt with blocks of time that are all of the same duration and are all aligned in time. For example, it is known for all generators and suppliers to exchange half-hour blocks of electricity, each starting and ending on the hour and half-hour. Furthermore, these exchanges are made well in advance of the half-hour blocks. This approach means that it is necessary to accurately predict future energy generation and/or consumption in order to optimise the exchange. It is apparent that, in such circumstances, generators and suppliers are unable to respond to unpredicted changes in supply of and demand for electricity as and when they arise. In particular, this constraint requires a generator to commit to supplying a certain amount of energy over the half-hour block, which may deter smaller generators, particularly those generating electricity from renewable sources such as solar and wind. Furthermore, by requiring a minimum amount of electrical energy to be exchanged, due to the reliance on half-hour blocks, it becomes impossible for smaller generators and suppliers (such as end user generators and consumers) to participate in the exchange due to the prohibitive cost. According to a first aspect of the present invention there is provided a microgrid control apparatus for controlling energy flow within a microgrid, the microgrid having an input/output, the microgrid control apparatus being associated with one or more items of energy consumption and/or generation equipment, wherein the microgrid control apparatus comprises: an energy monitor configured to monitor energy consumption and/or generation by the items of equipment to produce equipment energy data representative of energy consumption and/or generation in a prior time period; a nomination unit configured to nominate a future time period to produce time period data representative of a time of the future time period and a length of the future time period; a transceiver configured to transfer the equipment energy data and the time period data between the microgrid control apparatus and at least one other microgrid control apparatus for controlling energy flow within the microgrid; a processor configured to select a source/sink for consumed/generated energy, to be used during the future time period, wherein the processor is configured to select the source/sink based on the equipment energy data and the time period data of the microgrid control apparatus and the at least one other microgrid control apparatus.

In this way, exchanges of electrical energy may be for blocks of time having arbitrarily small durations, over which a change in energy consumption and/or generation may be neglected. In addition, exchanges of electrical energy may be for time periods arbitrarily soon, also over which a change in energy consumption and/or generation may be neglected. Therefore, according to the present invention, there is no need to make predictions about future energy generation and/or consumption, which greatly simplifies energy exchange.

The microgrid control apparatus may monitor energy consumption and/or generation, receive a value representing energy consumption/generation associated with at least one other microgrid control apparatus, and select a source/sink accordingly. In this way, flow of energy within the microgrid may be arranged by the microgrid control apparatus to minimise and/or avoid passage through the input/output of the microgrid.

The prior time period and/or the future time period may be spaced from the present time by less than approximately 30 minutes. For instance, the prior time period and/or the future time period may be spaced from the present time by less than approximately 20 minutes, 10 minutes, 5 minutes, 2 minutes, 1 minute, 40 seconds, 30 seconds, 20 seconds or 10 seconds. In this way, exchanges of electrical energy may be for blocks of time arbitrarily soon. Therefore, the effect is to make the markets more responsive to emerging conditions.

The length of the future time period may be less than approximately 30 minutes. For instance, the length of the future time period may be less than approximately 20 minutes, 10 minutes, 5 minutes, 2 minutes, 1 minute, 40 seconds, 30 seconds, 20 seconds or 10 seconds. In this way, exchanges of electrical energy may be for blocks of time having arbitrary and/or various durations. Therefore, the effect is to make the markets more responsive to emerging conditions, and to encourage small traders to join the markets. The nomination unit may be configured to nominate a future time period based on nomination data.

The nomination data comprise at least one of: user instructions relating to spacing of the future time period from the present time; user instructions relating to length of the future time period; change data representative of a rate of change in energy consumption and/or generation in the prior time period; and change data representative of equipment energy prediction data.

The equipment energy prediction data may be representative of a prediction of likely future energy consumption and/or generation by the items of equipment in a predefined future time period. The equipment energy prediction data may be generated by a prediction unit.

In particular, a microgrid control apparatus may take account of historical energy use, consider how this may change in the future, and infer future energy use. The microgrid control apparatus may include a form of feedback control that allows modification of future energy use be individual items of equipment so as to achieve a desired future energy use. The microgrid control apparatus may be configured to share the inferred future energy use with similar microgrid control apparatuses, and may also share an indication of the worth of the future consumed and/or generated energy, in the form of a weighting function, price, cost or other suitable value. There may be one or more of the microgrid control apparatuses on a microgrid, for instance all of the microgrid control apparatuses on the microgrid, may be configured to collate this use and/or worth data from each of the microgrid control apparatuses, together with similar data for energy supplied from an energy supplier external to the microgrid. Each microgrid control apparatus may be configured to optimise energy production and/or use, or alternatively or additionally, to optimise exchange of weighting functions / values, to improve efficiency of energy flow.

An end user may have only one or more than one item of energy consumption and/or generation equipment. An end user may have only one or more than one microgrid control apparatus for controlling energy flow within a microgrid. An end user may have only one or more than one item of energy consumption and/or generation equipment associated with each microgrid control apparatus for controlling energy flow within a microgrid.

The microgrid control apparatus may comprise a calculation unit configured to assign a value to the energy consumption and/or generation equipment. This may be based on predicted likely future energy consumption and/or generation and/or based on prior energy consumption and/or generation. The transceiver may be configured to transmit and receive the value assigned to the energy consumption and/or generation equipment. The processor may be configured to select the source/sink based on the value of the energy consumption and/or generation equipment. The value may indicate the relative importance or impact of the energy consumption and/or generation equipment. The value may be a weighting factor. The value may be a price. The price may be a hypothetical and/or virtual currency. Alternatively, the price may be linked to a real currency.

The microgrid control apparatus for controlling energy flow within a microgrid may be associated with energy consumption and/or generation equipment if it is operably connected thereto.

The energy consumption equipment may include energy storage equipment, as it will consume energy for later use. Similarly, the energy generation equipment may include energy storage equipment, as it may provide an input of stored energy into the microgrid. The source/sink may be associated with at least one other microgrid control apparatus for controlling energy flow within the microgrid, and/or the input/output of the microgrid.

The source/sink may be energy generation and/or consumption equipment which may be monitored by at least one other microgrid control apparatus for controlling energy flow within the microgrid.

The transceiver may be configured to receive energy data from a source external to the microgrid, and the prediction unit may be configured to predict likely future energy consumption and/or generation based on the energy data. The energy data may be third-party information and may be selected from the list comprising road traffic reports, weather forecasts, national energy use statistics and television schedules. In this way, the quality of predictions is increased, thereby leading to improved selection of source/sink. The third-party information may be sent to the transceiver by a third-party and/or may be requested by the microgrid control apparatus.

The transceiver may be configured to communicate via the internet, via the microgrid and/or via a telecommunication network. The transceiver may be configured to communicate with a smart meter, such that the energy monitor receives data from the smart meter.

The microgrid control apparatus for controlling energy flow within the microgrid may communicate directly with at least one other such microgrid control apparatus. Alternatively, the communication may be indirect; that is, via an intermediary.

The transceiver may be further configured to transmit and receive the equipment energy use data, and the processor may be further configured to select the source/sink based on the equipment energy data of the microgrid control apparatus and the at least one other microgrid control apparatus. In particular, the transceiver may be configured to receive, from at least one other microgrid control apparatus for controlling energy flow within the microgrid, a value of energy consumption and/or generation equipment associated with the at least one other microgrid control apparatus. The calculation unit may be configured to assign a value to the energy consumption and/or generation equipment, based on the value of energy consumption and/or generation equipment associated with the at least one other microgrid control apparatus.

The transceiver may be further configured to receive energy supplier energy use data, wherein the energy supplier energy data may indicate energy consumption and/or generation external to the microgrid at the input/output in the prior time period, and the processor may be further configured to select the source/sink based on the energy supplier energy use data. The transceiver may be further configured to receive energy supplier energy prediction data, wherein the energy supplier energy prediction data may indicate likely future energy consumption and/or generation external to the microgrid at the input/output, and the processor may be further configured to select the source/sink based on the energy supplier energy prediction data. In particular, the transceiver may be configured to receive a value of energy consumption and/or generation equipment external to the microgrid and the calculation unit is configured to assign a value to the energy consumption and/or generation equipment, based on the value of energy consumption and/or generation equipment external to the microgrid. In this way, the value may be assigned based on an external standard, such as an exchange rate, a price of electricity on a public market, or a virtual unit agreed by an independent body.

The microgrid control apparatus may further comprise an equipment controller configured to control operation of the items of equipment, based on the equipment energy data and/or the equipment energy prediction data. In particular, the equipment controller may be configured to control operation of the energy consumption and/or generation equipment, based on prior energy consumption and/or generation and/or based on the predicted likely future energy consumption and/or generation.

The equipment controller may be configured to connect and/or disconnect the energy consumption and/or generation equipment with the microgrid. The equipment controller may be configured to activate and/or deactivate the energy consumption and/or generation equipment. The equipment controller may be configured to operate the energy consumption and/or generation equipment, for instance by varying the power drawn by the items of equipment, or altering the load of the items of equipment.

In this way, the microgrid control apparatus may interact with consumption and/or generation equipment to optimise energy flow.

The equipment controller may be configured to control flow of electricity to energy consumption/generation equipment. For example, it may be configured to switch loads or generation equipment.

The equipment controller may be configured to request an operator manually control operation of the energy consumption/generation equipment in order to improve energy flow.

The equipment energy prediction data may include a number defining a relative value of the likely future energy consumption and/or generation compared to prior energy consumption and/or generation. The number may be a single number defining a relative value of the likely future energy consumption and/or generation, for all of the items of equipment. The number may be a plurality of numbers, each defining a relative value of the likely future energy consumption and/or generation for each of the items of equipment. The number may be an indication of the worth of the future consumed and/or generated energy, in the form of one of more of a weighting function, price, cost or other suitable value. The number may be a value of the worth or importance of the energy consumption and/or generation equipment, based on predicted likely future energy consumption and/or generation.

The equipment energy data may include a number defining a relative value of energy consumption and/or generation in the prior time period compared to a predetermined baseline. The number may be a single number defining a relative value of energy consumption and/or generation in the prior time period, for all of the items of equipment. The number may be a plurality of numbers, each defining a relative value of energy consumption and/or generation in the prior time period, for each of the items of equipment. The number may be an indication of the worth of the future consumed and/or generated energy, in the form of one of more of a weighting function, price, cost or other suitable value. The number may be a value of the worth or importance of the energy consumption and/or generation equipment.

The calculation unit may be configured to assign a value to the energy consumption and/or generation equipment, based on controlled operation of the energy consumption and/or generation equipment. In this way, control of the energy consumption and/or generation equipment may allow for a feedback signal to be sent to the calculation unit to dynamically update, for instance in real time, the assigned value. The calculation unit may be configured to determine a net value of the energy consumption and/or generation equipment associated with the control device. The calculation unit may be configured to determine a respective value of each item of energy consumption and/or generation equipment associated with the control device.

Selection of a source/sink may comprise comparing the prior energy consumption and/or generation (or the predicted likely future energy consumption and/or generation requirements) with a value of the energy consumption and/or generation equipment associated with at least one other microgrid control apparatus for controlling energy flow within a microgrid.

Selection of a source/sink may comprise negotiation between at least two microgrid control apparatuses. Negotiation may comprise a first microgrid control apparatus sending a first value to a second microgrid control apparatus, the second microgrid control apparatus rejecting the first value, based on a pre-determined threshold configuration set by a user, and sending a second value to the first microgrid control apparatus, and the first microgrid control apparatus accepting the second value in preference to the first rejected value. Multiple iterations of negotiation may occur in selecting a single source/sink. Selection of source/sink based on assigned values may constitute a local trading contract. Local trading contracts may include provision for fall-back agreements, such that failure to meet an agreed supply commitment between each microgrid control apparatus would result in purchase of energy from outside the microgrid (i.e. via the input/output, for example from a conventional energy supplier). For instance, if the sun goes behind a cloud, contrary to weather forecast prediction, and therefore the predicted amount of generation is not met, the necessary electricity may be bought from a grid supplier and/or incumbent supplier in order to fulfil the shortfall.

In this way, a microgrid control apparatus could make local trading contacts on the basis of its best guess at future load and generation, report post-facto the actual load and generation, and have a settlement process to reconcile the contract commitment to the actual events.

In particular, where a microgrid control apparatus does not support control of consumption and/or generation equipment, the microgrid control apparatus may, for instance, communicate with an end user's metering device, for instance a smart meter or meter connected to a computer monitoring system, to record the actual energy flows in a relevant time period, and later report them (with the trading contracts/agreements made) to a third party to effect financial reconciliation. Such a settlement process may be implemented in the context of an existing national supplier, which would already have systems for usage accounting and charging.

In some arrangements, the microgrid control apparatus may be configured to select the source/sink based on the equipment energy data and the time period data of the microgrid control apparatus and data external to the microgrid. In the above and following discussion, references selecting the source/sink based on the equipment energy data and the time period data of the at least one other microgrid control apparatus, may include selecting the source/sink based on equipment energy data and time period data from a source/sink external to the microgrid, and any values/prices and/or negotiations/reconciliations thus applied are to be construed accordingly.

The prediction unit may be configured to statistically analyse historical energy consumption and/or generation patterns and may be configured to infer future energy consumption and/or generation based on this analysis. The predefined future time period may have a length between approximately one minute and one year. The predefined future time period may be spaced from the present time period by between approximately one second and one year.

The microgrid control apparatus may comprise a user interface device such that a user may control predetermined threshold values and/or parameters for operation of the microgrid control apparatus. Alternatively, or additionally, the user interface device may provide feedback to an operator such that the operator may further improve energy flow within the microgrid.

Parameters may include, for example, how cheaply energy may be sold for, or of what exposure to market risk they will accept. The means of setting the parameters may be a local control or via a data communications network, such as the Internet, a GSM network and/or other telecommunication network. The transceiver may be a radio and/or microwave transceiver, and/or modem, and may be configured to communicate over a data communications network, such as the Internet, or a GSM/telecommunication network.

According to a second aspect of the invention, there is provided a method of controlling energy flow within a microgrid, the microgrid having an input/output, and the method comprising the steps of: providing a first microgrid control apparatus according to the first aspect associated with one or more first items of energy consumption and/or generation equipment; providing at least one second microgrid control apparatus according to the first aspect, associated with one or more second items of energy consumption and/or generation equipment; monitoring, with the energy monitor of the first microgrid control apparatus, energy consumption and/or generation by the first items of equipment to produce first equipment energy data; monitoring, with the energy monitor of the second microgrid control apparatus, energy consumption and/or generation by the second items of equipment to produce second equipment energy data; nominating, with the nomination unit of the first microgrid control apparatus, a first future time period to produce first time period data, and/or nominating, by the nomination unit of the second microgrid control apparatus, a second future time period to produce second time period data; transmitting, with the transceiver of the first microgrid control apparatus, the first equipment energy data and optionally the first time period data to the transceiver of the second microgrid control apparatus; receiving, with the transceiver of second microgrid control apparatus, the first equipment energy data and optionally the first time period data from the transceiver of the first microgrid control apparatus; and selecting, with the processor of the second microgrid control apparatus, a source/sink for consumed/generated energy, to be used during the first and/or second future time period, based on the first and second equipment energy data and the first and/or second time period data.

In this way, exchanges of electrical energy may be for blocks of time which do not all align in time. Therefore, the effect is to make the markets more responsive to emerging conditions, and to encourage small traders to join the markets.

The method may further comprise the steps of: accepting, with the second microgrid control apparatus, a first value from the first microgrid control apparatus in response to the first value being within a predetermined range; or rejecting, with the second microgrid control apparatus, the first value in response to the first value being outside the predetermined range; sending, with the second microgrid control apparatus, a refined first value to the first microgrid control apparatus; and accepting, with the first microgrid control apparatus, the refined first value in preference to the first value, in response to the second value being within a further predetermined range.

The method may further comprise the step of negotiating, between the first and second microgrid control apparatus, a refined first value and/or second value for use selecting the source/sink.

According to a third aspect of the present invention, there is provided a system for controlling energy flow within a microgrid, the microgrid having an input/output, the system comprising at least two microgrid control apparatuses according to the first aspect, and the system configured to carry out the method according to the second aspect. The system may comprise the microgrid and/or the energy consumption/generation equipment.

The system may comprise a local aggregator, configured to mediate negotiation between respective microgrid control apparatuses and between a microgrid control apparatus and a grid energy supplier. In particular, a local aggregator may represent end users collectively in trading with a grid supplier. For instance, a local aggregator may operate as an independent observer that monitors all trades in a microgrid. A local aggregator may also authenticate each microgrid control apparatus and/or each negotiation request, and may report current trading values/prices to a microgrid control apparatus or end user.

The first microgrid control apparatus, as part of the system, may propose a trade to the second microgrid control apparatus. These proposed trades may include assertions about periods of future time, quantities of electrical energy to be consumed/generated and values and/or prices. The second device may agree to the proposed trade, or attempt to negotiate a more favourable trade. Negotiation may be bilateral (between two microgrid control apparatuses) or multilateral (between more than two microgrid control apparatuses). The negotiation may be a haggle, an auction, reverse auction, a unique bid auction or some other negotiation and/or optimization technique. The microgrid control apparatus may compare competing proposed trades from a plurality of other microgrid control apparatuses, and may select the most economical trade, for instance, the cheapest price trade from the competing proposed trades. The microgrid control apparatus may have a predefined and/or predetermined strategy for selecting the most economical trade. For instance, the microgrid control apparatus may seek to minimise a net price by making multiple trades from different energy sources. The microgrid control apparatus may select a less economical trade in order to limit risk and/or potential loss due to market variability.

Negotiations between a first microgrid control apparatus and a second microgrid control apparatus may be peer-to-peer.

Each microgrid control apparatus on a microgrid may be discoverable by each other microgrid control apparatus. That is, each microgrid control apparatus may be able to be found by at least one other microgrid control apparatus. Each microgrid control apparatus may be configured to broadcast an identification signal that may be detectable by other microgrid control apparatuses. The broadcast may be continuous, intermittent and/or in response to an interrogation query. The identification signal may be unique to the microgrid control apparatus, and/or it may comprise a generic identifier of microgrid control apparatuses. Alternatively or additionally, each microgrid control apparatus may be recorded in a directory, which may be shared online, and/or may be accessible to a limited set of end users and/or subscribers. In particular, each microgrid control apparatus may be subject to authentication such that secure trading may be ensured. Authentication may be direct or via an intermediary, such as a certificate authority. An authentication server may be present on the microgrid and/or on a communication network such as the internet. Authentication may utilise public key infrastructure (PKI).

According to a fourth aspect of the present invention, there is provided computer program code means adapted to perform the steps of the method according to the second aspect, wherein said computer program code means is configured to be run on a computer.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 shows a simplified view of a typical energy transmission network in which the present invention may be incorporated.

FIG. 2 shows a simplified view of an end user location shown in FIG. 1.

FIG. 3 shows a simplified view of another end user location shown in FIG. 1.

FIG. 4 shows a simplified view of yet another end user location shown in FIG. 1.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and drawn not to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “connected”, used in the description, should not be interpreted as being restricted to direct connections only. Thus, the scope of the expression “a device A connected to a device B” should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may refer to different embodiments. Furthermore, the particular features, structures or characteristics of any embodiment or aspect of the invention may be combined in any suitable manner, as would be apparent to one of ordinary skill in the art from this disclosure, in one or more embodiments.

Similarly, it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may, in some embodiments, mean only one.

The invention will now be described by a detailed description of several embodiments of the invention. It is clear that other embodiments of the invention can be configured according to the knowledge of persons skilled in the art without departing from the underlying concept or technical teaching of the invention, the invention being limited only by the terms of the appended claims.

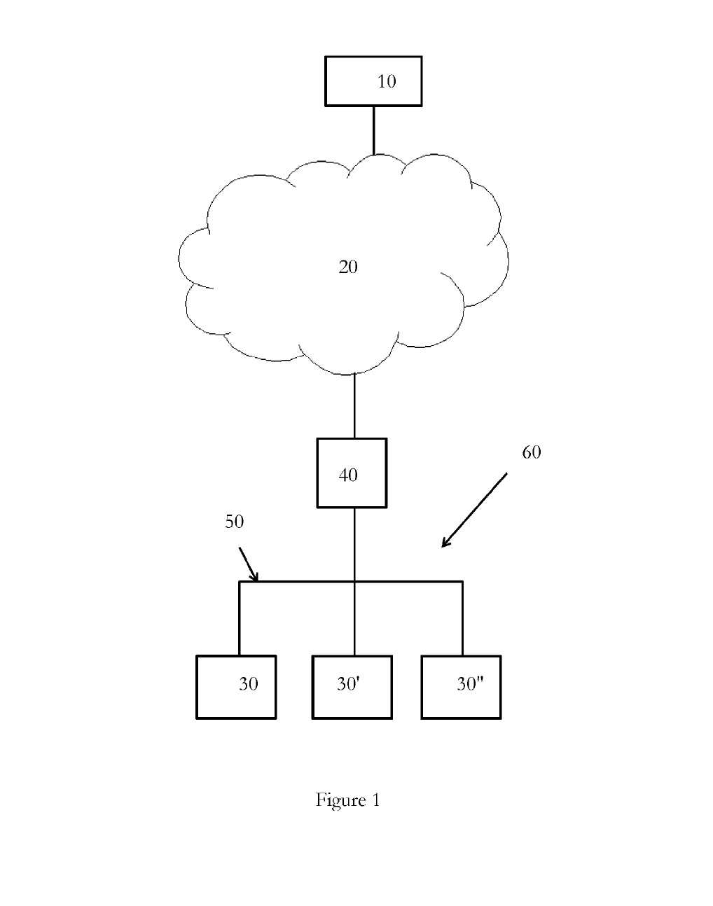

FIG. 1 shows a simplified view of a typical energy transmission network in which the present invention may be incorporated. At least one energy generator 10 is connected to a transmission/distribution network 20 (such as a regional/national grid). End user locations 30, 30′ and 30″ are also connected to the transmission/distribution network 20 via a transformer 40, to which they are connected by low voltage feeders 50. The end user locations 30 and low voltage feeders 50 constitute a microgrid 60 connected to the network 20 by a single input/output in the form of the transformer 40. Multiple generators 10, microgrids 60 and transformers 40 have been omitted for clarity. Only three end user locations 30 have been shown in the figure; however, typically, approximately two hundred homes or small businesses may be present on a single microgrid.

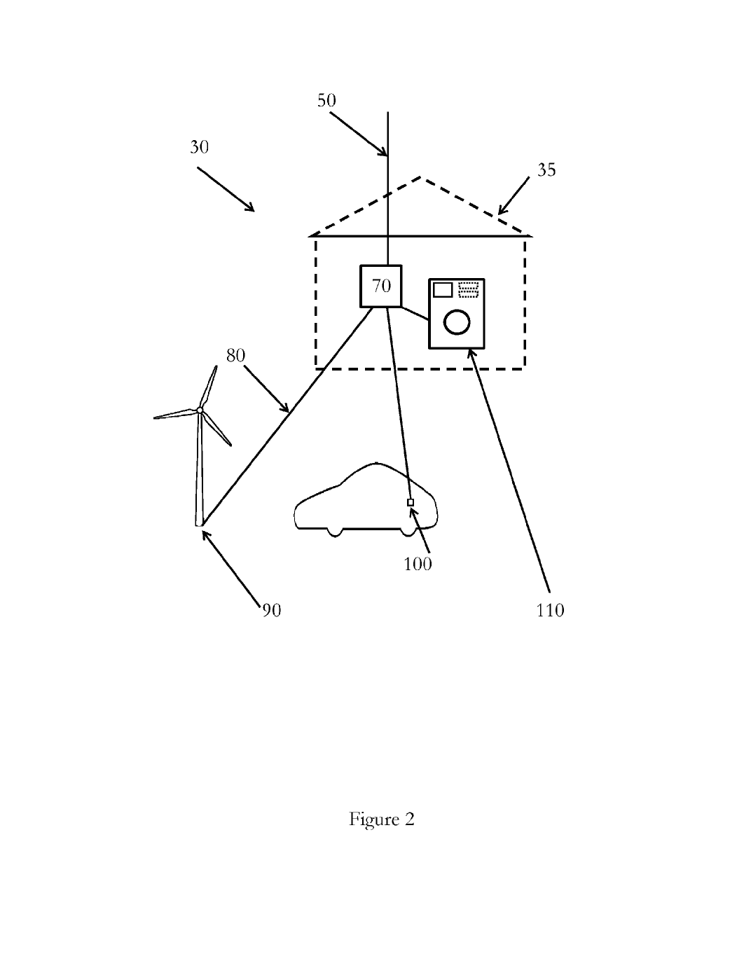

FIG. 2 shows a simplified view of an end user location 30. A microgrid control apparatus according to the present invention 70 is located within an end user premises and is connected to a low voltage feeder 50 on a microgrid 60. Electrical lines 80 connect the microgrid control apparatus 70 to energy generation equipment 90 (in this instance, a wind turbine), energy storage equipment 100 (in this instance, an electric car battery) and energy consumption equipment 110 (in this instance, a washing machine). It is appreciated that an end user at the end user location 30 may have multiple microgrid control apparatuses 70, energy generation equipment 90, energy storage equipment 100 and/or energy consumption equipment 110; however, only one of each has been show for clarity.

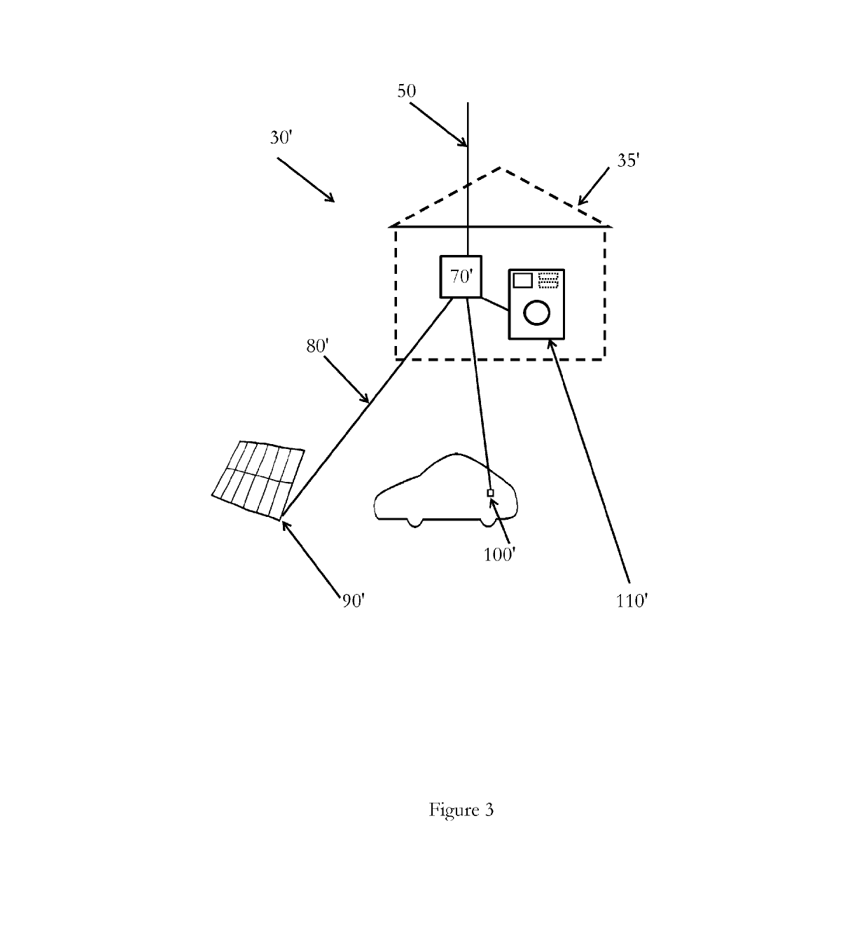

FIG. 3 shows a simplified view of an end user location 30′. A microgrid control apparatus according to the present invention 70′ is located within an end user premises and is connected to a low voltage feeder 50 on a microgrid 60. Electrical lines 80′ connect the microgrid control apparatus 70′ to energy generation equipment 90′ (in this instance, solar panels), energy storage equipment 100′ (in this instance, an electric car battery) and energy consumption equipment 110′ (in this instance, a washing machine). It is appreciated that an end user at the end user location 30′ may have multiple microgrid control apparatuses 70′, energy generation equipment 90′, energy storage equipment 100′ and/or energy consumption equipment 110′; however, only one of each has been show for clarity.

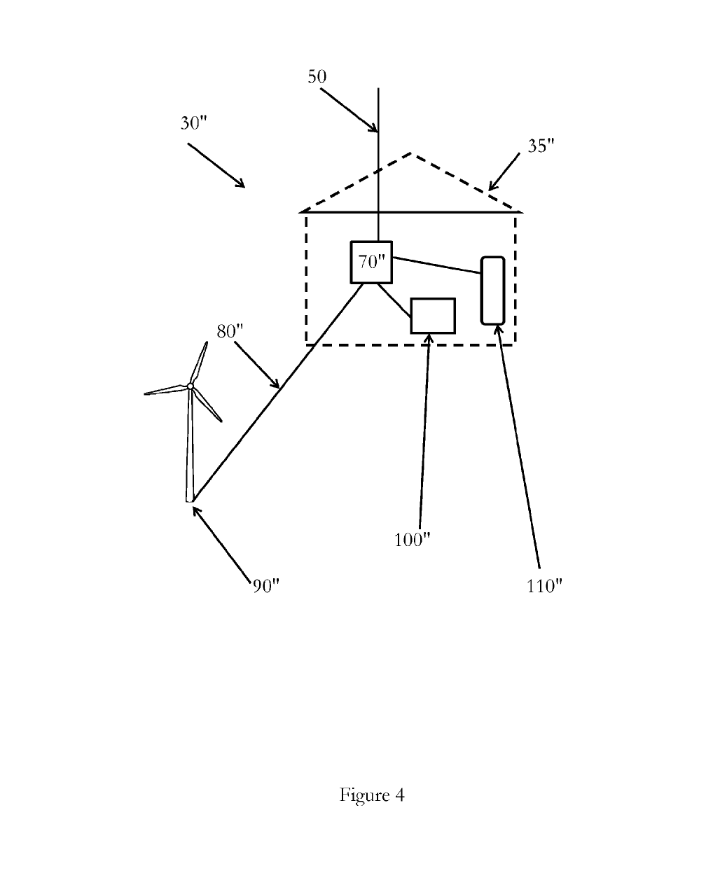

FIG. 4 shows a simplified view of an end user location 30″. A microgrid control apparatus according to the present invention 70″ is located within an end user premises and is connected to a low voltage feeder 50 on a microgrid 60. Electrical lines 80″ connect the microgrid control apparatus 70″ to energy generation equipment 90″ (in this instance, a wind turbine), energy storage equipment 100″ (in this instance, a dedicated storage battery) and energy consumption equipment 110″ (in this instance, a water heating unit). It is appreciated that an end user at the end user location 30″ may have multiple microgrid control apparatuses 70″, energy generation equipment 90″, energy storage equipment 100″ and/or energy consumption equipment 110″; however, only one of each has been show for clarity.

According to the present embodiment, the microgrid control apparatus 70 monitors energy generation of the energy generation equipment 90, energy stored in the energy storage equipment 100 and energy consumed by the energy consumption equipment 110. The microgrid control apparatus 70 then assumes future energy consumption by the car battery 100 and washing machine 110 and generation by the wind turbine 90 will not change in a first future time period immediately following the present time and lasting for 3 minutes. The microgrid control apparatus 70 then assigns a first generation value to the energy generation equipment 90 and a first consumption value to the energy consumption equipment 110. The microgrid control apparatus then transmits the first generation and consumption values to the microgrid control apparatus 70′.

The microgrid control apparatus 70′ monitors energy generation of the energy generation equipment 90′, energy stored in the energy storage equipment 100′ and energy consumed by the energy consumption equipment 110′. The microgrid control apparatus 70′ then assumes future energy consumption by the car battery 100′ and washing machine 110′ and generation by the solar panels 90′ in a second future time period beginning 1 minute after the present time and lasting for five minutes. The microgrid control apparatus 70′ then assigns a second generation value to the energy generation equipment 90′ and a second consumption value to the energy consumption equipment 110′.

The microgrid control apparatus 70′ then accepts the first generation value in response to the first generation value being within a predefined range, for instance less than the second consumption value, and rejects the first consumption value in response to the first consumption value being outside a further predefined range, for instance greater than the second generation value. The microgrid control apparatus 70′ then sends a refined first consumption value to the microgrid control apparatus 70, based on the first consumption and generation values and the second consumption and generation values, for instance a value mid-way between the first consumption value and the second generation value.

The microgrid control apparatus 70 then accepts the refined first consumption value in preference to the first consumption value, in response to the refined first consumption value being within a further predefined range, set by an end user, and sends a notification to the end user suggesting that the electric car battery 100 should be disconnected and the washing machine 110 should not be operated in this time period, in order to save energy.

Each of the microgrid control apparatuses 70, 70′ then selects the other microgrid control apparatus 70′, 70 as the source/sink for consumed/generated energy, to be used during the second predefined future time period.

The microgrid control apparatus 70 also transmits the first generation and consumption values to the microgrid control apparatus 70″.

The microgrid control apparatus 70″ monitors energy generation of the energy generation equipment 90″, energy stored in the energy storage equipment 100″ and energy consumed by the energy consumption equipment 110″. The microgrid control apparatus 70″ then assumes future energy consumption by the storage battery 100″ and water heater 110″ and generation by the wind turbine 90″ in a third future time period occurring 30 seconds after the present time and lasting 30 seconds. The microgrid control apparatus 70″ then assigns a second generation value to the energy generation equipment 90″ and a second consumption value to the energy consumption equipment 110″.

The microgrid control apparatus 70″ rejects the first consumption and generation values in response to the first consumption and generation values being outside a yet further predefined range. The microgrid control apparatus 70″ then selects the input/output as the source/sink for consumed/generated energy, to be used during the predefined future time period. In addition, the microgrid control apparatus 70″ automatically turns off the water heater during the predefined time period, based on a minimum acceptable temperature for hot water, pre-set by an end user.

In alternative embodiments, the microgrid control apparatus 70″ may automatically reduce power supplied to the storage battery 100″, may only charge the storage battery 100″ to a pre-defined level, or may draw electrical power from the storage battery 100″ to heat water in the water heater 110″ in favour of drawing power from the input/output of the microgrid 60.

1. A microgrid control apparatus for controlling energy flow within a microgrid, the microgrid having an input/output, the microgrid control apparatus being associated with one or more items of energy consumption and/or generation equipment, wherein the microgrid control apparatus comprises:
an energy monitor configured to monitor energy consumption and/or generation by the items of equipment to produce equipment energy data representative of energy consumption and/or generation in a prior time period;
a nomination unit configured to nominate a future time period to produce time period data representative of a time of the future time period and a length of the future time period;
a transceiver configured to transfer the equipment energy data and the time period data between the microgrid control apparatus and at least one other microgrid control apparatus for controlling energy flow within the microgrid;
a processor configured to select a source/sink for consumed/generated energy, to be used during the future time period, wherein the processor is configured to select the source/sink based on the equipment energy data and the time period data of the microgrid control apparatus and the at least one other microgrid control apparatus.

2. The microgrid control apparatus of claim 1, further comprising an equipment controller configured to control operation of the items of equipment, based on the equipment energy data.

3. The microgrid control apparatus of claim 2, wherein the equipment controller is configured to connect and/or disconnect the items of equipment with the microgrid.

4. The microgrid control apparatus of claim 1, wherein the source/sink is associated with the at least one other microgrid control apparatus, and/or the input/output of the microgrid.

5. The microgrid control apparatus of claim 1, wherein the source/sink is energy generation and/or consumption equipment that is monitored by the at least one other microgrid control apparatus, and/or the input/output of the microgrid.

6-7. (canceled)

8. The microgrid control apparatus of claim 1, wherein the transceiver is further configured to receive energy supplier energy use data, wherein the energy supplier energy use data indicates energy consumption and/or generation external to the microgrid at the input/output in the prior time period, and the processor is further configured to select the source/sink based on the energy supplier energy data.

9. The microgrid control apparatus of claim 1, wherein the equipment energy data includes a number defining a relative value of energy consumption and/or generation in the prior time period compared to a predetermined baseline energy consumption and/or generation.

10. (canceled)

11. The microgrid control apparatus of claim 2, wherein the equipment controller is configured to vary the power drawn by the items of equipment.

12. The microgrid control apparatus of claim 1, wherein the prior time period and/or the future time period is spaced from the present time by less than 30 minutes.

13. The microgrid control apparatus of claim 1, wherein the length of the future time period is less than 30 minutes.

14. The microgrid control apparatus of claim 1, wherein the nomination unit is configured to nominate a future time period based on nomination data.

15. The microgrid control apparatus of claim 14, wherein the nomination data comprise at least one of:
user instructions relating to spacing of the future time period from the present time;
user instructions relating to length of the future time period;
change data representative of a rate of change in energy consumption and/or generation in the prior time period; and
change data representative of equipment energy prediction data.

16. The microgrid control apparatus of claim 9, wherein the number is a single number defining a relative value of energy consumption and/or generation in the prior time period, for all of the items of equipment.

17. The microgrid control apparatus of claim 9, wherein the number is a plurality of numbers, each defining a relative value of energy consumption and/or generation in the prior time period, for each of the items of equipment.

18. A method of controlling energy flow within a microgrid, the microgrid having an input/output, and the method comprising the steps of:
providing a first microgrid control apparatus according to claim 1, associated with one or more first items of energy consumption and/or generation equipment;
providing at least one second microgrid control apparatus according to claim 1, associated with one or more second items of energy consumption and/or generation equipment;
monitoring, by the energy monitor of the first microgrid control apparatus, energy consumption and/or generation by the first items of equipment to produce first equipment energy data;
monitoring, by the energy monitor of the second microgrid control apparatus, energy consumption and/or generation by the second items of equipment to produce second equipment energy data;
nominating, by the nomination unit of the first microgrid control apparatus, a first future time period to produce first time period data;
transmitting, by the transceiver of the first microgrid control apparatus, the first equipment energy data and the first time period data to the transceiver of the second microgrid control apparatus;
receiving, by the transceiver of second microgrid control apparatus, the first equipment energy data and the first time period data from the transceiver of the first microgrid control apparatus; and
selecting, by the processor of the second microgrid control apparatus, a source/sink for consumed/generated energy, to be used during the first future time period, based on the first and second equipment energy data and the first time period data.

19. A system for controlling energy flow within a microgrid, the microgrid having an input/output, the system comprising at least two microgrid control apparatuses of claim 1, and the system configured to carry out a method of controlling energy flow within a microgrid, the microgrid having an input/output, and the method comprising the steps of:
providing a first microgrid control apparatus according to claim 1, associated with one or more first items of energy consumption and/or generation equipment;
providing at least one second microgrid control apparatus according to claim 1, associated with one or more second items of energy consumption and/or generation equipment;
monitoring, by the energy monitor of the first microgrid control apparatus, energy consumption and/or generation by the first items of equipment to produce first equipment energy data;
monitoring, by the energy monitor of the second microgrid control apparatus, energy consumption and/or generation by the second items of equipment to produce second equipment energy data;
nominating, by the nomination unit of the first microgrid control apparatus, a first future time period to produce first time period data;
transmitting, by the transceiver of the first microgrid control apparatus, the first equipment energy data and the first time period data to the transceiver of the second microgrid control apparatus;
receiving, by the transceiver of second microgrid control apparatus, the first equipment energy data and the first time period data from the transceiver of the first microgrid control apparatus; and
selecting, by the processor of the second microgrid control apparatus, a source/sink for consumed/generated energy, to be used during the first future time period, based on the first and second equipment energy data and the first time period data
